(19) United States
(12) Patent Application Publication
(10) Pub. No.: US 2021/0317931 A1
(43) Pub. Date: Oct. 14, 2021

(54) HAMMERLESS AND TORQUELESS UNION CONNECTION AND METHOD

(71) Applicant: Todd Anthony Travis, Humble, TX (US)

(72) Inventor: Todd Anthony Travis, Humble, TX (US)

(21) Appl. No.: 16/844,354

(22) Filed: Apr. 9, 2020

(51) Int. Cl. F16L 19/02

(52) U.S. Cl. CPC F16L 19/0206; F16L 19/0218

(57) ABSTRACT

A system and method for creating a union connection that is hammerless and torque-less. In one embodiment, the union connection has a male pipe that is inserted into a collar. A plurality of ring segments of a segmented ring is inserted and housed in a groove between the inner surface of the collar and the outer surface of the male pipe. Then a female pipe is inserted into the collar as well. The female pipe engages with the male pipe, and is engaged with the collar. Lastly, a pin is inserted into a hole in the collar that is coaxial with a pocket located on the exterior surface of the female pipe.

### BACKGROUND

### Technical Field

The present disclosure relates generally to a union connection. More particularly, and not by way of limitation, the present disclosure is directed to a system and method for a union connection that does not require hammering or torquing during installation.

### Description of Related Art

This background section is intended to provide a discussion of related aspects of the art that could be helpful to understanding the embodiments discussed in this disclosure. It is not intended that anything contained herein be an admission of what is or is not prior art, and accordingly, this section should be considered in that light.

Union connections are commonly used to join pipes together and can be found throughout various industries, including the oil and gas industry. Typically, a union connection is made by screwing together a male pipe and a female pipe with a collar. To create an effective seal, the two sides of a union fitting can be tightened or torqued down by using a hammer to turn a nut that pulls the two sides of the union together. This type of work requires a worker to swing a large hammer against the union. This can be very unsafe, and it puts unnecessary strain on the worker throughout the connection process.

When union connections are assembled incorrectly, personal injury can result. Other tools such a torque gun can further complicate the process and lengthen the time required to assemble the union connection. What is needed is a hammerless and torqueless union connection that can be assembly with reduced risk of personal injury, while effectively creating a seal that can withstand the grueling demands of the oil and gas industry and other industries.

An objective of the present disclosure is to provide a device that can be a hammerless and torque-less union connection and a method of using the device. The connection device should simplify the process of creating a union connection by eliminating the need for a hammer and/or a torque gun to complete a union connection, thereby reducing the amount of strain and/or injury to the user.

### BRIEF SUMMARY

This summary provides a discussion of aspects of certain embodiments of the invention. It is not intended to limit the claimed invention or any of the terms in the claims. The summary provides some aspects but there are aspects and embodiments of the invention that are not discussed here.

The present disclosure provides a hammerless and torqueless union connection and a method thereof. Specifically, a plurality of retainer ring segments, a collar, a male pipe, a female pipe, and a pin are combined in one embodiment. A male pipe end is joined to a female pipe end. A collar can be fitted over this connection using a segmented retainer ring housed in a groove between the inner surface of the collar and the outer surface of the male pipe to hold the collar in place. A hole in the collar can be used to engage a locking pin through the collar to a pocket in the female pipe to lock the connection in place.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is an assembly section perspective view of an embodiment of a union connector.

FIG. 2 is a side cross-section view of an alternative embodiment of a union connector.

FIG. 3 is a partial side cross-section assembly view of an alternative embodiment of a union connector showing a locking pull-pin engaged.

FIG. 4 is a partial side cross-section assembly view of the union connector of FIG. 3 showing the locking pull-pin disengaged.

FIG. 5 is partial side cross-section assembly view of the union connector of FIG. 3 showing the locking pull-pin disengaged at an intermediate step of assembly or disassembly of the union connector.

FIG. 6 is a partial side cross-section assembly view of an alternative embodiment of a union connector assembly showing a two-piece captured locking pin engaged.

FIG. 7 is a partial side cross-section assembly view of the union connector of FIG. 6 showing the two-piece captured locking pin disengaged.

FIG. 8 is an exploded perspective view of the two-piece captured locking pin of FIG. 6.

FIG. 9 is a close-up perspective cross-section view of the second thread surface of the collar of the union connector of FIG. 6.

FIG. 10 is a partial side cross-section assembly view of an alternative embodiment of a union connector showing a two-piece locking key engaged.

FIG. 11 is a partial side cross-section assembly view of the union connector of FIG. 10 showing the two-piece locking key disengaged.

FIG. 12 is an exploded view of the two-piece locking key of FIG. 10.

FIG. 13 is a close-up perspective view of an inner collar surface of an embodiment of a union connector showing the exit aperture of the locking pin hole and its interior threads.

FIG. 14 is a close-up perspective view of the exterior female pipe surface of an embodiment of a union connector showing the pocket for engaging a locking pin and the threads intended to engage with matching threads on a collar.

FIG. 15 is a partial cross-section assembly view of an alternative embodiment of a union connector showing a one-piece captured locking screw engaged.

FIG. 16 is partial cross-section assembly view of an alternative embodiment of a union connector showing a one-piece captured locking screw disengaged.

FIG. 17 is a close-up perspective view of the locking screw of an embodiment of a union connector in the disengaged position.

FIG. 18 is a front perspective exploded assembly view of an embodiment of a union connector.

FIG. 19 is a rear perspective exploded assembly view of an embodiment of a union connector.

FIG. 20 is a top assembly view of an embodiment of a union connector showing a female pipe end partially inserted into the collar.

FIG. 21 is a top assembly view of an embodiment of a union connector showing a female pipe partially inserted into the collar.

FIG. 22 is a partial side cross-section assembly view of the embodiment of FIG. 21 the locking key removed.

FIG. 23 is a top view of an embodiment of a union connector assembly showing a female pipe fully inserted into the collar.

FIG. 24 is a cross-section of an embodiment of a retaining ring housed between two separate components held together by the retaining ring.

### DETAILED DESCRIPTION

All illustrations of the drawings are for the purpose of describing selected version of the present invention and are not intended to limit the scope of the present invention. The present invention can be constructed of a wide variety of materials that are known to one of ordinary skill in the art. However, it is preferred that the present invention be constructed of a material that is strong, durable, tough, weather-resistant, and/or easily manufacturable.

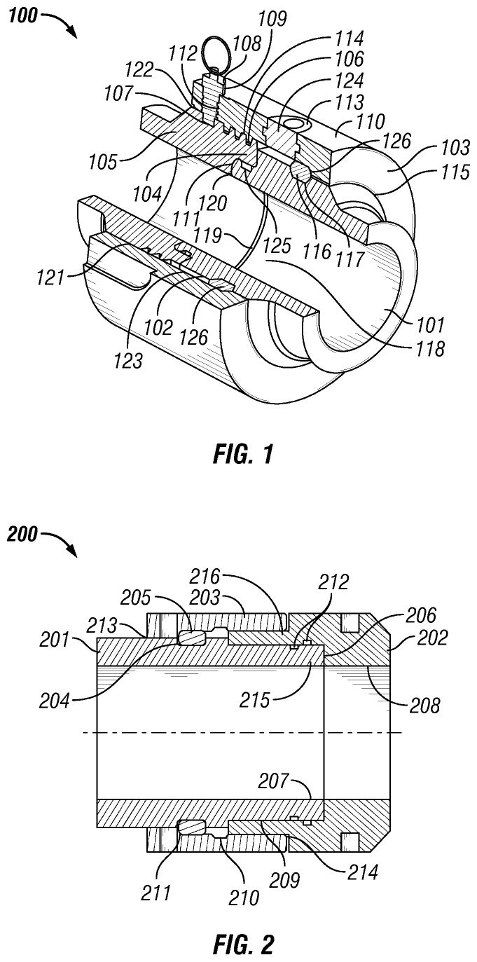

FIG. 1 is an assembly section perspective view of an embodiment of a union connector. A male pipe end 118 of a male pipe 101 can be inserted through a first aperture 115 of a collar 103. The outside diameter of a male pipe exterior surface 102 is smaller than the inside diameter of the collar interior surface 123. This allows for the inserted male pipe 101 to pass through the collar 103 until the male pipe end 118 meets a female pipe 105. The female pipe 105 can be inserted into the collar 103 through a second aperture 122. Along the female pipe exterior surface 121 of the female pipe 105 there is a first threaded surface 106. The first threaded surface 106 matches with a second threaded surface 114 located along the collar inner surface 123 of the collar 103.

As the female pipe end 104 is inserted into the collar 103, the first threaded surface 106 threads with the matching second threaded surface 114 of the collar, coupling the female pipe 105 to the collar 103. Once inserted into the collar 103, the female pipe 105 is located adjacent to the male pipe 101. The male pipe 101 and female pipe 105 interface along a male/female interface 111. A retainer hole 113 resides in the collar exterior surface 110 of the collar 103 providing a passageway from the exterior surface 110 to the interior of the collar 103. Near the male/female interface 111, an o-ring trench 125 traverses the circumference of the male pipe exterior surface 102. An o-ring (not shown) can be housed in the o-ring trench 125 to create a seal between the male pipe 101 and female pipe 105. After assembly, the male pipe aperture 119 is coaxial with a female pipe aperture 120 as shown in FIG. 1.

On the male pipe exterior surface 102 there is a male pipe groove 117. The male pipe groove 117 traverse the circumference of the male pipe exterior surface 102 and can have the shape of an isosceles trapezoid. As the male pipe 101 is joined with the collar 103, the collar inner surface 123 slides along the male pipe exterior surface 102 of the male pipe 101. When the collar 103 is engaged with the mail pipe exterior surface 102 but before the collar is fully engaged with the female pipe end 104, the male pipe groove 117 can be accessed via the retainer hole 113. When the male pipe groove 117 is aligned with the retainer hole 113, a segmented ring 116 can be inserted into the male pipe groove 117. The segmented ring 116 has multiple segments that combine together to form a retainer ring. A cross-section of the segments can have a hexagon shape to mate with the isosceles trapezoid shape of the mail pipe groove 117. After the segmented ring 116 has been inserted into the male pipe groove 117, the segmented ring 116 is housed in the groove so that the angled sides of the segmented ring 116 mate to the angled sides of the male pipe groove 117.

As discussed in greater detail below, the isosceles trapezoid shape of the male pipe groove 117 and the hexagonal shape of each the ring segment allow the ring segment 116 to be placed compression instead of shear when fluid pressure is applied to the union connection. Once the segmented ring 116 has been inserted through the retainer hole 113, the collar 103 can be tightened around the threaded surface 106 of the female pipe 105 until a collar groove 126 that is located on the collar inner surface 123 is pulled adjacent to the segmented ring 116. The collar groove 126 also has a partial isosceles trapezoidal shape on one end for mating with the segmented ring 116.

Once fully assembled, the segmented ring 116 is securely housed between the male pipe exterior surface102 and the collar inner surface 123 to prevent the male pipe 101 from being pulled out of the collar 103 when fluid pressure is applied. Other embodiments of the collar groove 126 can have a full isosceles trapezoidal shape, not a partial isosceles trapezoidal shape as shown in FIG. 1. In such an embodiment, the retainer hole could be placed such that it is aligned upon full assembly to allow the retainer ring to be installed.

After the segmented ring 116 has been inserted through the retainer hole 113, a retainer plug 124 can be inserted and secured into the retainer hole 113. Near the second aperture 122 on the collar 103 is a locking pin hole 109. When the female pipe 105 has been inserted and fully screwed into the collar 103, the locking pin hole 109 becomes coaxial with a pocket 107 that is located on the female pipe exterior surface 121. A locking pin 108 can be inserted through the locking pin hole 109 and into the pocket 107 to prevent movement of the collar with respect to the female pipe. A locking pin threaded surface 112 lines the locking pin hole 109 and matches with a corresponding threaded surface on the locking pin 108. When the male pipe 101 and the female pipe 105 have been inserted and secured inside the collar 103, the segmented ring 116 has been housed in between the male pipe groove 117 and collar groove 126, and the locking pin 108 has been inserted through the collar 103 into the pocket 107 on the female pipe 105, the union connection is fully assembled and sealed without the need for a hammer or a torque assistance device to create the seal.

FIG. 2 is a side cross-section view of an alternative embodiment of a union connector. A male pipe 201 can be inserted into a first aperture 213 of the collar 203 so that the collar 203 slips past the male pipe groove 204 that resides along the male pipe exterior surface 209. Once the segmented ring 205 is assembled, the segmented ring 205 with a cross-section oval shape is inserted into the groove whose shape matches the shape of the male pipe groove 204 to allow a snug fit. Other embodiments of the segmented ring 205 can have other cross-sectional shapes such as a rectangle or a hexagon. In the second aperture 214 which is located on the opposite side of the collar 203 from the first aperture 213, a female pipe 202 can be inserted until it interfaces with the male pipe 201. A male/female interface 206 runs along the surface of the female pipe 202 that abuts against the male pipe 201. On the male pipe end 215 and on the female pipe end 216, there are o-ring trenches 212 that house an o-ring (not shown) to create a seal. The o-ring trenches 212 and the o-rings (not shown) are housed within the male pipe exterior surface 209 and female pipe interior surface 208.

The interface between the collar 202 and the female pipe 202 can be threaded in a similar manner as that discussed above with reference to FIG. 1. As the female pipe 202 is screwed into the collar 203, it pulls the collar 203 to engage the collar with the segmented ring 205 housed in the male pipe groove 204. Due to the configuration of the segmented ring 205, the load path runs through the segmented ring 205 to the male pipe 201. The segmented ring 205 pushes on the male pipe groove 204 which pushed the male pipe 201 into the female pipe 202. Once the pocket located on the female pipe exterior surface is coaxial with a locking pin hole on the collar outer surface, a pin is inserted and secured through the collar 203 and into the pocket.

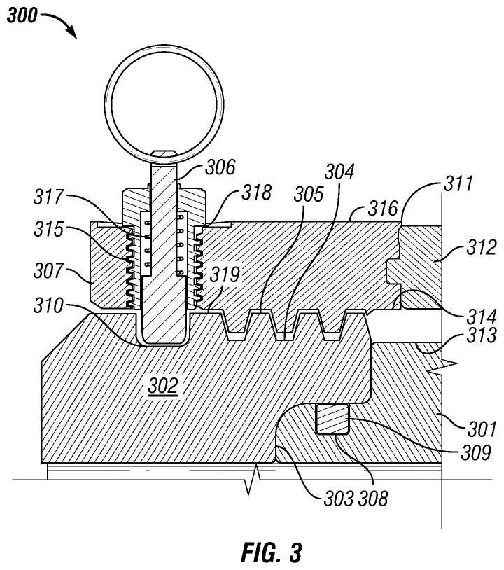

FIG. 3 is a partial side cross-section assembly view of an alternative embodiment of a union connector showing a locking pull-pin engaged. Both the male pipe 301 and the female pipe 302 have been inserted into the collar 307. Along the interface where the male pipe 301 and female pipe 302 meet is a male/female interface 303. An o-ring trench 308 traverses the circumference of the male pipe exterior surface 313 and houses an o-ring 309. First threaded surface 304 on the female pipe exterior surface 319 has been threaded with a matching second threaded surface 305 on the collar inner surface 314. Along the collar outer surface 316 is a retainer hole 311 and a locking pin hole 318. A retainer plug 312 is inserted into the retainer hole 311, and a spring-loaded locking pin 306 has been inserted into a locking pin hole 318. Along the corridor of the locking pin hole 318 is a locking pin hole threaded surface 315 that matches with a threaded surface on the outer sleeve of the locking pin 306. When aligned, the spring mechanism 317 pushes the locking pin 306 into the pocket 310, securing the locking pin 306 through the collar 307 and in the female pipe 302 such that the collar 307 is secured with the female pipe 302.

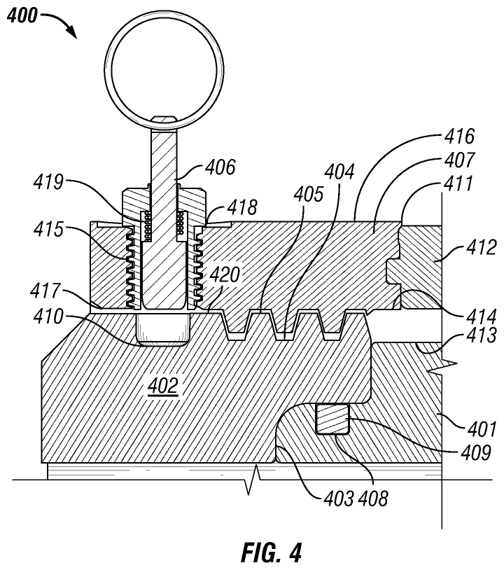

FIG. 4 is a partial side cross-section assembly view of the union connector of FIG. 3 showing the locking pull-pin disengaged. In the displayed embodiment, the male pipe 401 has is fully inserted into the collar 407. Likewise, the female pipe 402 is fully inserted into the collar 407 through the second aperture 41, placing the male pipe 401 adjacent to the female pipe 402 at the male/female interface 403. Along the male/female interface 403, an o-ring trench 408, houses an o-ring 409 to create a seal between the pipes 401, 402. First threaded surface 404 on the female pipe outer surface 420 of the female pipe 402 are fully engaged with a matching second threaded surface 405 that resides on the collar inner surface 414.

The retainer hole 411 has already had the segmented ring (not shown) inserted through it into the male pipe groove (not shown), and the retainer plug 412 has subsequently been inserted to prevent anything else from passing into the area between the collar inner surface 414 and the male pipe outer surface 413. The locking pin 406 has been inserted into the locking pin hole 418, and the locking pin 406 threaded surface has been engaged by matching threaded surface on the outer sleeve of the locking pin 406. However, the locking pin mechanism 419 has been pulled upward to allow the union connector to be disassembled.

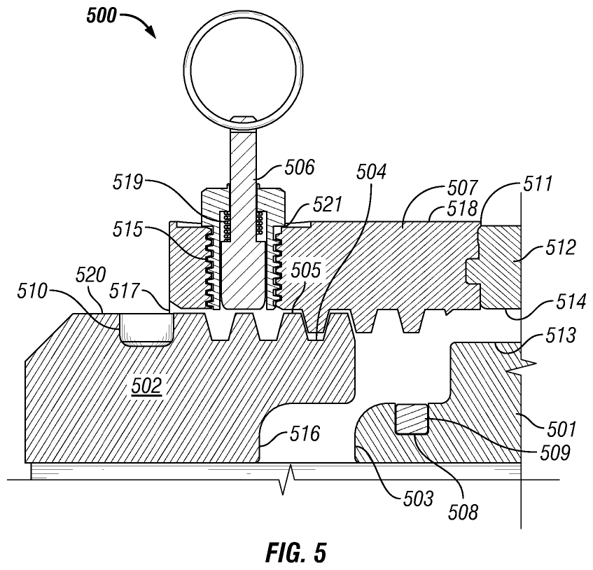

FIG. 5 is partial side cross-section assembly view of the union connector of FIG. 3 showing the locking pull-pin disengaged at an intermediate step of assembly or disassembly of the union connector. The male pipe 501 is shown fully inserted into the collar 507. A retainer plug 512 has been fitted into the retainer hole 511 that is located along the collar outer surface 518 and segmented ring (not shown) is installed. The female pipe 502, is partially engaged as evidenced by the mating of first threaded surface 504 and second threaded surface 505 located on the collar inner surface 514. While the locking pin 506 is disengaged and is resting on the first threaded surface 504 as the female pipe 502 is screwed in our out. The pocket 510 located along the female pipe outer surface 520 exposed in this intermediate position of the collar 507. As a result, the locking pin hole 521 is not coaxial with the pocket 510.

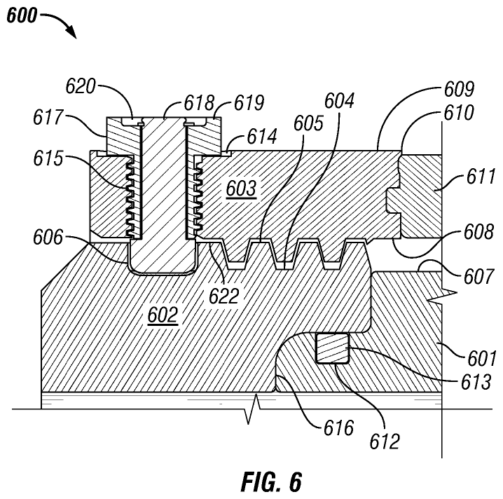

FIG. 6 is a partial side cross-section assembly view of an alternative embodiment of a union connector assembly showing a two-piece captured locking pin engaged. The alternate embodiment illustrated in FIG. 6 has an alternate means of securing the collar 603 to the female pipe 602. As with previous embodiments, the male pipe 601 is inserted into the collar 603. A segmented ring is also housed in between the male pipe outer surface 607 in a male pipe groove and the collar inner surface 608 after being inserted through the retainer hole 610. The retainer hole 610 houses the retainer plug 611. Once inserted fully, the male pipe 601 engages an inserted female pipe 602 along a male/female interface 616. An o-ring 613 housed in an o-ring trench 612 traverses the circumference of the male pipe outer surface 607 and is located near the male/female interface 616. A first threaded surface 604 located along the female pipe outer surface 622 has engages a second threaded surface 605 located on the collar inner surface 608.

A two-piece locking pin 617 is inserted into the locking pin hole 614 that penetrates the collar outer surface 609. The two-piece locking pin 617 consists of an outer sleeve 619 having a threaded surface matching a locking hole threaded surface 615, as well as an inner post 618. After the inner post 618 is inserted into the locking sleeve 619, a retaining ring 620 is used to secure the inner post 618 to the locking sleeve 619 at the portion of the inner post 618 that protrudes from the top of the locking sleeve 619. The female pipe 602 in the alternate embodiment displayed in FIG. 6 has a pocket 602 which is larger than previous embodiments. As the two-piece locking pin 617 is screwed into the locking pin hole 614, the two-piece locking pin 617 is inserted into the enlarged pocket 606, securing the collar 603 to the female pipe 602.

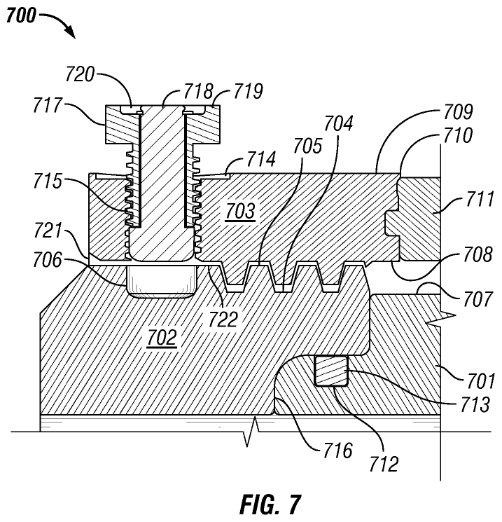

FIG. 7 is a partial side cross-section assembly view of the union connector of FIG. 6 showing the two-piece captured locking pin disengaged. The two-piece locking pin 717 in FIG. 7 is partially screwed out of locking pin hole 714. The locking pin threaded surface 715 that lines the locking pin hole 714 engages the matching threaded surface along the outer sleeve 719. The male pipe 701 has been inserted into the collar 703 which engages with the female pipe 702 that was inserted through the second aperture 721 at a male/female interface 716. Matching first threaded surface 704 and second threaded surface 705 couple the female pipe 702 to the collar 703. The retainer hole 710 houses the retainer plug 711, and the segmented ring is housed in between the collar inner surface 708 and the male pipe outer surface 707. An o-ring 713 in housed in an o-ring trench 712 located along the male/female interface 716.

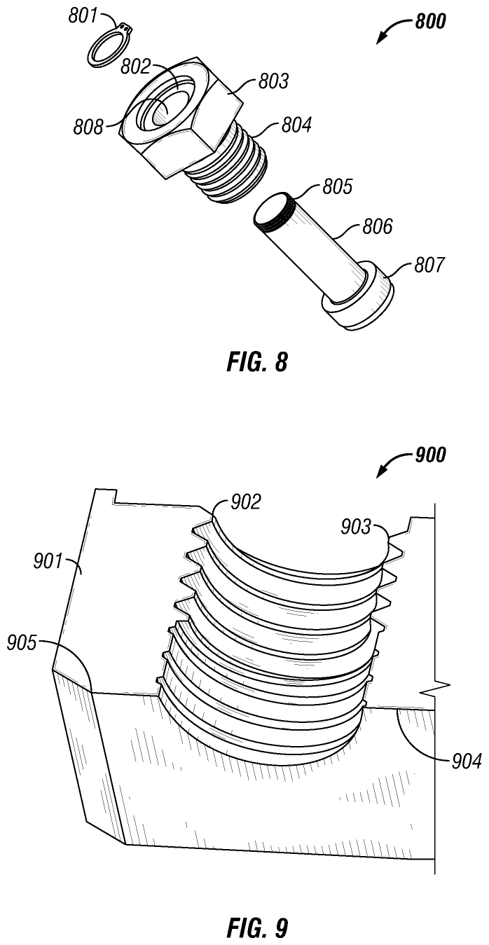

FIG. 8 is an exploded perspective view of the two-piece captured locking pin of FIG. 6. An outer sleeve 803 has a stud hole 808 that allows for the inner post 806 to be inserted through it. The inner post 806 has a retaining ring groove 805 on one end and a locking nub 807 on the other. A retaining ring 801 engages the retaining room grooved 805 to hold the inner post 806 in the outer sleeve 803. Once the two-piece locking pin 800 has been inserted through a collar and into the pocket of a female pipe, the locking nub 807 sits inside the pocket and secures the collar to the female pipe.

FIG. 9 is a close-up perspective cross section view of the second threaded surface of the collar of the union connector of FIG. 6. The locking pin hole 902 is located on the collar 901 and allows for the two-piece locking pin to be screwed into it. On the collar inner surface 904 is the second aperture 905 through which a female pipe can be inserted. The female pipe slides along the collar inner surface 904 until a pocket is coaxial with the locking pin hole 902. As the locking pin is inserted and a locking hole threaded surface 903 is engaged, the locking pin traverses through the entire the locking pin hole 902 until it protrudes out the other end and rests in the coaxial pocket on the surface of the female pipe.

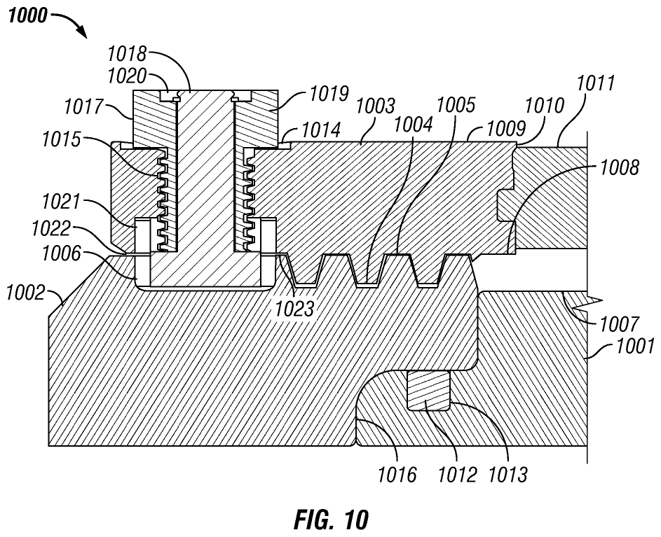

FIG. 10 is a partial side cross-section assembly view of an alternative embodiment of a union connector showing a two-piece locking key engaged. The two-piece locking pin 1017 is installed in the locking pin hole 1014 on the collar outer surface 1009. Locking pin threaded surface 1015 is engaged with matching threaded surface on the outer sleeve 1019 of the two-piece locking pin 1017. The inner post 1018 is secured in the outer sleeve 1019 by a locking ring 1020. A female pipe 1002 penetrates a second aperture 1022 so that a first threaded surface 1004 on the female pipe outer surface 1023 engages a second threaded surface 1005 on the collar inner surface 1008. A segmented ring can be inserted through the retainer hole 1010 so that it is housed between the collar inner surface 1008 and the male pipe outer surface 1007. A retainer plug 1011 can cover the retainer hole 1010. An o-ring 1012 is housed in an o-ring trench 1013 along the male/female interface 1016.

The collar 1003 is different from previously disclosed embodiments in that it has a recess pocket 1021 located along the locking pin hole 1014 and the collar inner surface 1008. The recess pocket 1021 allows the locking pin 1017 to be inserted and engaged with the locking pin hole 1014 prior to the insertion of the female pipe 1002 into the second aperture 1022 on the collar 1003. Once the female pipe 1002 has been inserted and the locking pin hole 1014 is coaxial with the pocket 1006 on the female pipe 1002, the two-piece locking pin 1017 can be moved from the recess pocket 1021 into the pocket 1006 on the female pipe 1002. This allows for an alternate method of assembly of the union connection such that the locking pin can be preassembled prior to assembly of the union connection in the field.

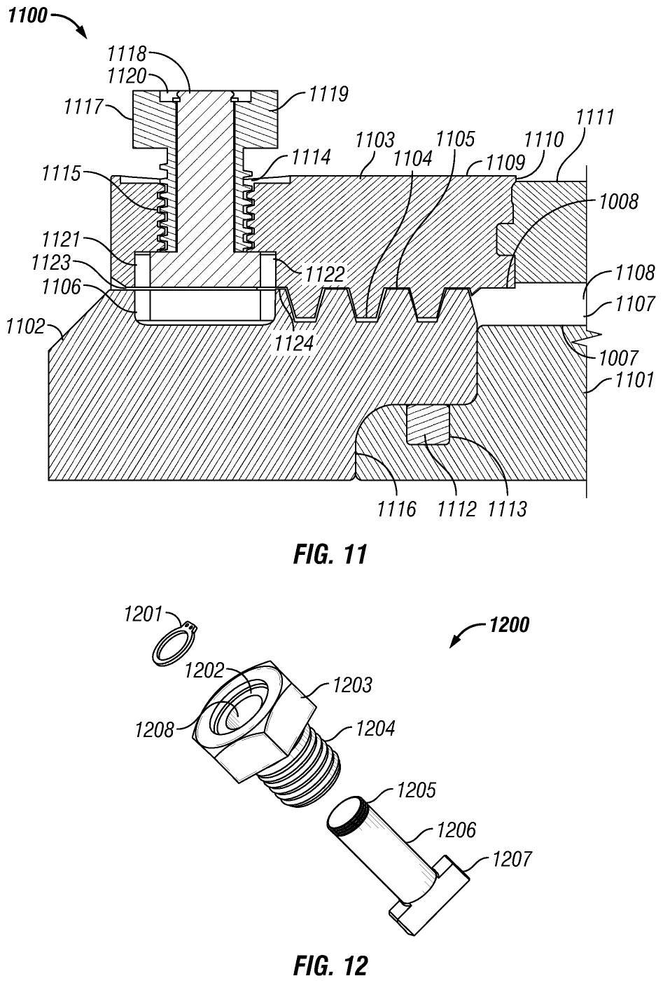

FIG. 11 is a partial side cross-section assembly view of the union connector of FIG. 10 showing the two-piece locking key disengaged. The two-piece locking pin 1117 is partially inserted into the locking pin hole 1114 located on the collar outer surface 1109. A locking pin threaded surface 1115 that lines the locking pin hole 1114 is engaged with the matching threaded surface on the outer sleeve 1119 of the two-piece locking pin 1117. One end of the inner post 1118 is secured to the outer sleeve 1119 by a locking ring 1120. On the other end, the locking pin nub 1122 is housed in the recess pocket 1121 located on the collar inner surface 1008. Even though the female pipe 1102 has been inserted into the second aperture 1123 of the collar 1103, the first threaded surface 1104 on the female pipe outer surface1124 has been threaded into the second threaded surface 1105 on the collar 1103, and the locking hole 1114 is coaxial with the pocket 1106 on the female pipe 1102, the two-piece locking pin 1117 is not inserted into the pocket 1106 and does not secure the collar 1103 to the female pipe 1102. The o-ring 1112 is housed in the o-ring trench 1113 along the male/female interface 1116. The segmented ring is housed between the collar inner surface 1108 and the male pipe outer surface 1107. The retainer plug 1111 is inserted into the retainer hole 1110.

FIG. 12 is an exploded view of the two-piece locking key of FIG. 10. The alternate embodiment of the two-piece locking pin 1200 has a bar 1207 located on the lower end of the inner post 1206. The bar 1207 is intended to fit into a slot on the female pipe instead of a pocket, as with previous embodiments. The inner post 1206 is inserted into the outer sleeve 1203 and secured by a locking ring 1201 in retaining ring groove 1202. The outer sleeve 1203 has sleeve threaded surface 1204 that can engage a threaded surface of a locking pin hole in a collar.

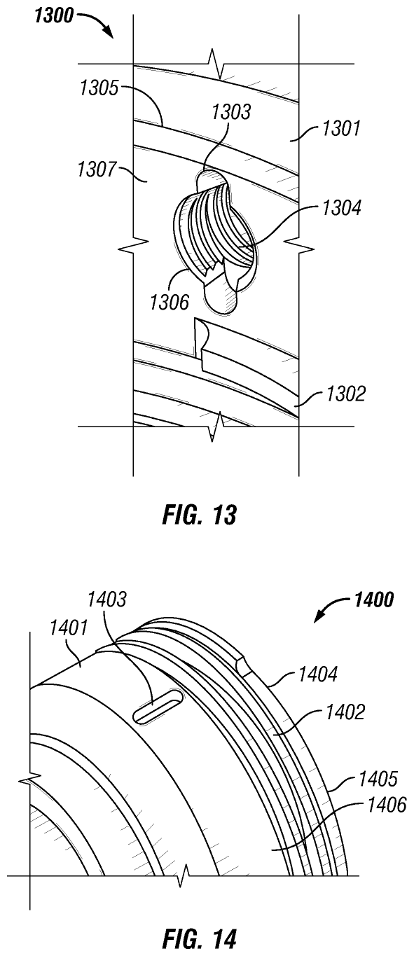

FIG. 13 is a close-up perspective view of an inner collar surface of an embodiment of a union connector showing the exit aperture of a locking pin hole and its interior threads. The lower aperture 1306 of the locking pin hole is located on the inner collar surface 1307. Both the locking hole threaded surface 1304 that lines the locking hole and the second threaded surface 1302 that is located along the collar inner surface 1307 are visible in FIG. 13. The recess pocket 1303 can house the locking nub of a two-piece locking pin. The locking nub of the locking pin can reside in the recess pocket 1303 while a female pipe is inserted through the second aperture 1305 on the collar 1301.

FIG. 14 is a close-up perspective view of the exterior female pipe surface of an embodiment of a union connector showing the pocket for engaging a locking pin and the threads intended to engage with matching threads on a collar. The female pipe 1401 has a female pipe outer surface 1406 and a female pipe inner surface (not shown). When the female pipe 1401 is inserted into a collar, the female pipe inner surface lines up so that the female pipe fluid channel is coaxial with a male pipe fluid chamber. On the female pipe outer surface 1406, a slit 1403, can engage with the locking nub of a locking pin. The slit can accommodate a bar of similar shape. Closer to the female pipe insertion end 1404 is the first threaded surface 1404 that can be screwed into matching threads located on a collar inner surface. The female pipe interface 1405 is adjacent to the female pipe insertion end 1404 and is intended to engage with a male pipe interface after being inserted into a collar.

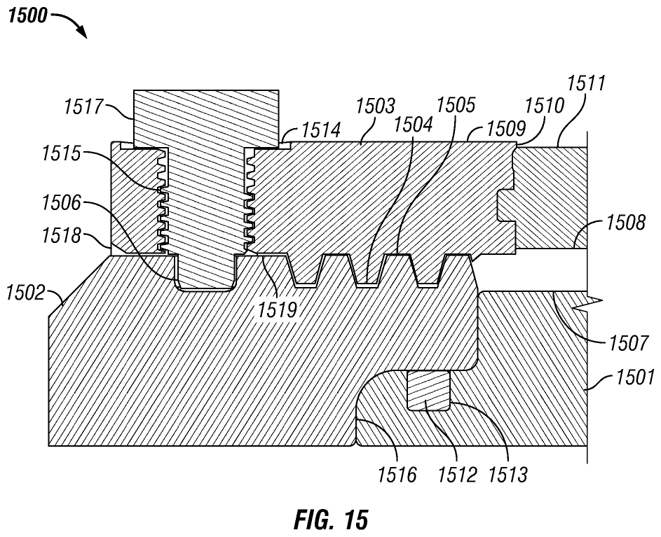

FIG. 15 is a partial cross-section assembly view of an alternative embodiment of a union connector showing a one-piece captured locking screw engaged. A male pipe 1501 mates with the collar 1503 and a segmented ring (not shown) housed between the male pipe outer surface 1507 and the collar inner surface 1508. The male pipe 1501 contains an o-ring 1512 in an o-ring trench 1513 adjacent to a male/female interface 1516. On the opposite end of the collar 1503, a female pipe 1502 penetrates a second aperture 1518 on the collar 1503. A second threaded surface 1505 on the collar inner surface 1508 engages with a first threaded surface 1504 on the female pipe outer surface 1519 such that the collar 1503 can screwed onto the female pipe 1502. A locking pin hole 1514 on the collar is aligned with a pocket 1506 located on the female pipe outer surface 1519. A locking screw 1517 in the locking pin hole 1514 engages with a locking pin threaded surface 1515. The base of the locking screw 1517 engages the pocket 1506 to secure the collar 1503 from moving relative to the female pipe 1502.

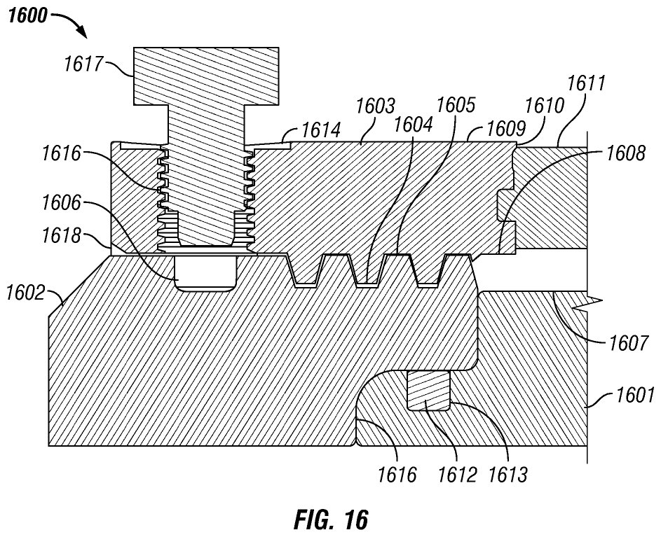

FIG. 16 is partial cross-section assembly view of an alternative embodiment of a union connector showing a one-piece captured locking screw disengaged. The locking screw 1617 is partially inserted into the locking screw hole 1614 located on the end of the collar 1603 adjacent to the second aperture 1618. The female pipe 1602 penetrates the second aperture 1618, and engages at a male/female interface 1616 with a male pipe 1601. The male pipe 1601 houses a segmented ring (not shown) in a male pipe groove and between the male pipe outer surface 1607 and a collar inner surface 1608. A retainer plug 1611 covers the retainer hole 1610. A first threaded surface 1604 on the female pipe 1602 mates with a second threaded surface 1605 on the collar 1603; and an o-ring 1612 can be housed in an o-ring trench 1613. With the locking screw 1617 partially engaged as shown, the union connector can be screwed/unscrewed to assemble/disassemble.

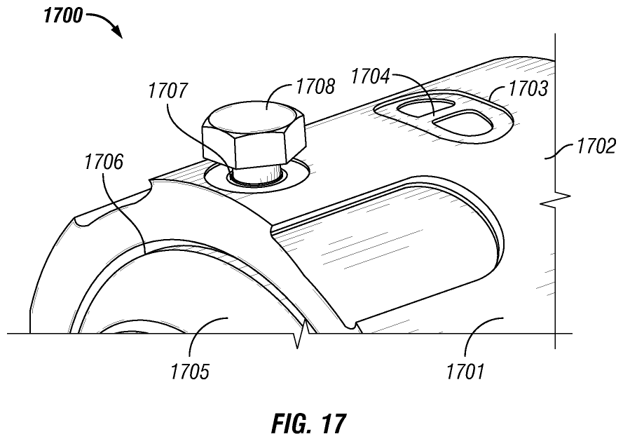

FIG. 17 is a close-up perspective view of the locking screw of an embodiment of a union connector in the disengaged position. The female pipe 1705 penetrates the second aperture 1706 on the collar 1701. Along the collar outer surface 1702, a locking screw hole 1707 protrudes through the collar 1701. The locking screw 1708 engages with the locking screw hole 1707. On the opposite end of the collar 1702, a retaining plug 1704 covers a retainer hole 1703.

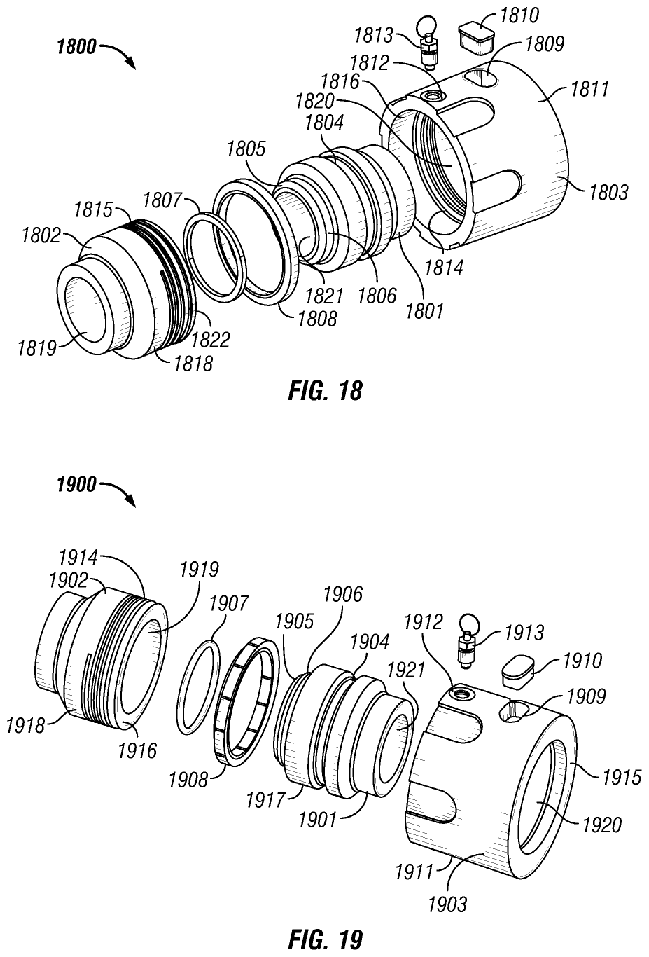

FIG. 18 is a front perspective exploded assembly view of an embodiment of a union connector. A male pipe end 1801 has a male pipe groove 1804 and an o-ring trench 1806. The segmented ring 1808 housed in the male pipe groove 1804, and the o-ring 1807 housed in the o-ring trench 1806. After the male pipe end 1801 has been inserted into a first aperture (not shown) on a distal end of the collar 1803 and the segmented ring 1808 has been inserted through the retaining hole 1809 to engage with the male pipe groove 1804, a retaining plug 1810 is inserted into the retaining hole 1809. On the proximal end of the collar 1803 and through a second aperture 1816, the female pipe end 1802 is inserted. A first threaded surface 1815 on the female pipe end outer surface 1818 is threaded into a second threaded surface 1814 located on the collar inner surface 1820. Once the locking pin hole 1812 on the collar outer surface 1811 is coaxial with the pocket (not shown) on the female pipe outer surface 1818, a locking pin 1813 is inserted into the locking pin hole 1812 so that it engages the pocket (not shown), securing the collar 1803 to the female pipe 1802. A female pipe end inner surface 1819 is now in line with a male pipe end inner surface 1821 such that a conduit is made that allows fluid to travel between the male pipe end 1801 and the female pipe end 1802.

FIG. 19 is a rear perspective exploded assembly view of an embodiment of a union connector. A male pipe end 1901 with a male pipe fluid channel 1921 is inserted through a first aperture 1915 on a collar 1903 until the male pipe groove 1904 is aligned with the retainer hole 1909. A segmented ring 1908 is inserted into the retainer hole 1909 and housed in the male pipe groove 1904. The segmented ring 1908 traverses the circumference of the male pipe end outer surface 1917 and has a cross-section hexagon shape so that its sides abut against the isosceles trapezoidal shape of the male pipe groove 1904 and a collar groove (not shown). Once the ring is installed, the plug 1910 can be inserted into the retainer hole 1909. Then the collar 1903 can be pulled away from the male pipe end 1901 to cause the segmented retainer to engage with the collar groove.

Then a female pipe end 1902 is inserted through a second aperture (not shown) on the opposite side of the collar 1903. The collar is screwed onto threads 1914 located on the female pipe end until the male interface 1905 mates with the female interface 1916. The male pipe fluid channel 1921 is in line with a female pipe fluid channel 1919.

As the female pipe end 1902 is engaged with the collar 1903 via the threaded surface of the first threaded surface 1914, the pocket (not shown) is covered by the collar 1903. At some point during the insertion of the female pipe 1902, the pocket along the female pipe outer surface 1918 will become coaxial with the locking hole 1912 located on the collar outer surface 1911. At this point, the locking pin 1913 is inserted into the locking pin hole 1912, allowing the locking pin 1913 to be engaged with the pocket.

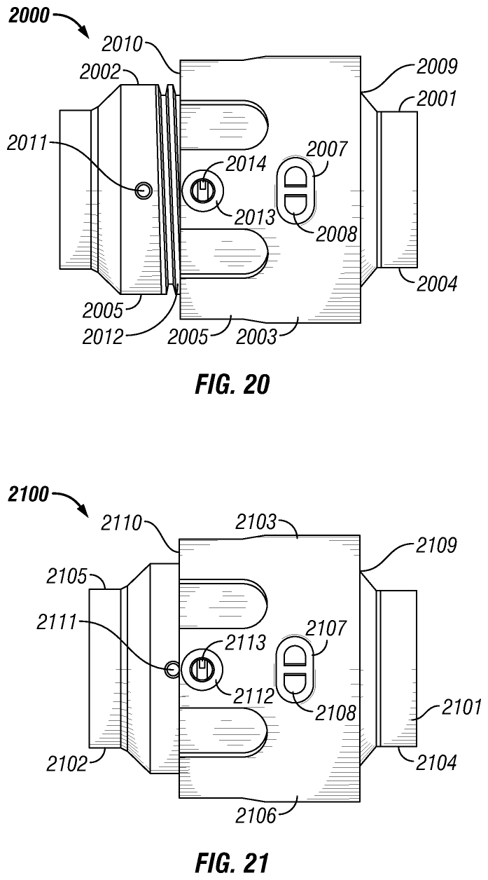

FIG. 20 is a top assembly view of an embodiment of a union connector showing a female pipe end partially inserted into the collar. The male pipe end 2001 shown fully inserted into the collar 2003 through the first aperture 2009 such that the male pipe outer surface 2004 is adjacent to a collar inner surface. The female pipe end 2002 is partially inserted into the second aperture 2010. Portions of the second threaded surface 2012 along the female pipe outer surface 2005 are shown. The retainer plug 2008 is in the retainer hole 2007. The locking pin 2014 has been inserted into the locking pin hole 2013, but the locking pin 2014 is not fully engaged because it is not aligned with the locking pocket 2011.

FIG. 21 is a top assembly view of an embodiment of a union connector showing a female pipe partially inserted into the collar. As in FIG. 20, the male pipe 2101 is fully inserted into the first aperture 2109 of the collar 2103, and the retainer plug 2108 is installed in the retainer hole 2107 that resides on the collar outer surface 2106. A segmented ring (not shown) is housed between a male pipe outer surface 2104 and a collar inner surface. The locking pin 2113 is in the locking pin hole 2112, but is not engaged with the pocket 2111 on the female pipe outer surface 2105.

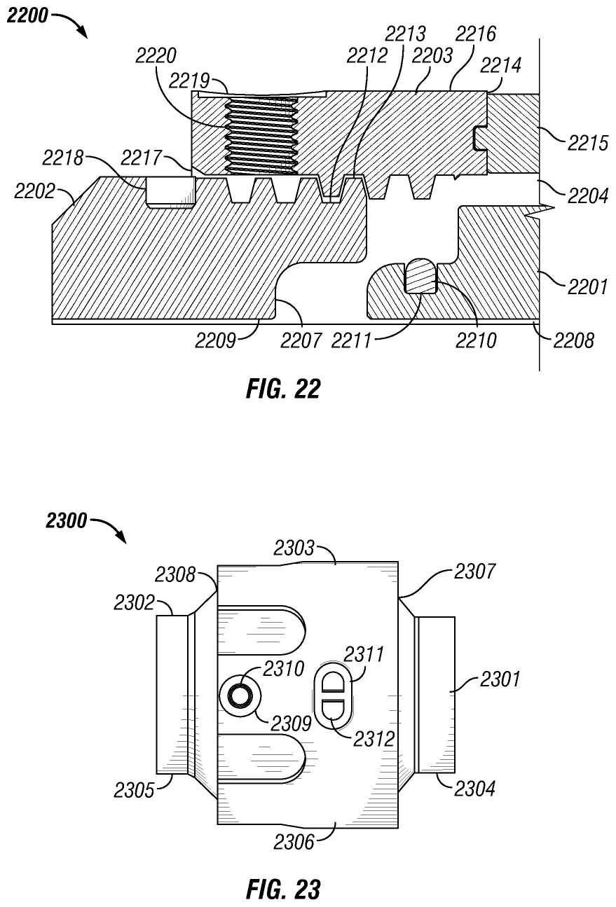

FIG. 22 is a partial side cross-section assembly view of the embodiment of FIG. 21 with the locking pin removed. As in FIG. 21, the female pipe end 2202 is partially inserted into the second aperture 2217 of the collar with a first threaded surface 2212 being engaged with the second threaded surface 2213. The pocket 2218 is not aligned with the locking pin hole 2219. Continuing to screw the collar 2203 onto the female pipe end 2202 will cause the pocket 2218 to become aligned with the locking hole 2219. The locking pin can then be inserted into the locking pin hole 2219 and engaged with the pocket 2218. The segmented ring is housed between the inner collar surface 2204 and the male pipe outer surface. A female pipe fluid channel 2209 can be in line with a male pipe fluid channel 2208 so that fluid may pass between them; and the o-ring 2210 housed in the o-ring trench 2211 can engage with the female pipe interface 2207 to create a seal.

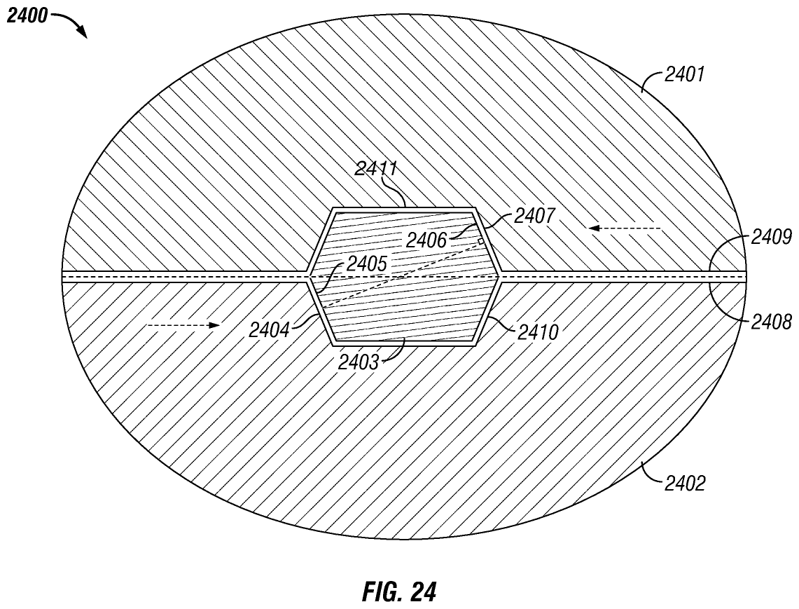

FIG. 23 is a top view of an embodiment of a union connector assembly showing a female pipe fully inserted into the collar. The male pipe 2301 is shown fully inserted into the collar 2303 via a first aperture 2307, and the female pipe 2302 is shown fully inserted into the collar 2303 through the second aperture 2308. The segmented ring is housed along the male pipe outer surface 2304 in the male pipe groove, and the retainer plug 2312 covers the retainer hole 2311 located along the outer collar surface 2306. The locking pin 2310 is fully inserted into the locking hole 2309 and engaged with the pocket on the female pipe outer surface 2305. Thus, the union connector assembly is fully assembled.

FIG. 24 is a cross-section of an embodiment of a retaining ring housed between two separate components held together by the retaining ring. Such a retaining ring when segmented into a number of pieces can be used in the union connector as described above. The first component 2401 (which could be a collar) is placed adjacent a second component 2402 (which could be a male pipe end). The retaining ring 2403 is housed in a first groove 2410 (which could be a male pipe groove) and a second groove 2411 (which could be a collar groove). The first groove 2410 and the second groove 2411 can have an isosceles trapezoidal shape such that the cross section of the retaining ring 2403 has a hexagon shape that mates with the second groove 2411 on the top side and the first groove 2410 on the bottom side.

In the context of a union connection, after the union connector has been assembled as disclosed herein and pressure applied, a female pipe pulls on the collar 2401. In turn, the collar bearing surface 2407 pushes on the second ring bearing surface 2406. The male pipe 2402 presses the male pipe bearing surface 2404 against the first ring bearing surface 2405. The collar bearing surface 2407 can be configured so that a perpendicular line drawn from the center of the bearing surface 2407 intersects somewhere along the male pipe bearing surface 2404. By designing the segmented ring 2403 in this manner, when pressure is applied, compression force is applied to the load ring rather than shear force.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure but should not be constrained by the headings set forth herein.

We claim:

1. A union connection assembly comprising:
a collar comprising a collar groove on an inner circumference of the collar;
a male pipe, wherein the male pipe comprises a male pipe groove on an outer circumference of the male pipe and wherein the male pipe is configured to be inserted into a first aperture of the collar;
a female pipe, wherein the female pipe is configured to be inserted into a second aperture of the collar; and
a segmented ring configured to be housed in a passageway formed by the collar groove and the male pipe groove for bearing a load between the collar and the male pipe.

2. The union connection assembly of claim 1 wherein the male pipe comprises, a male pipe end and a first interface at a rim of the male pipe end, wherein the female pipe comprises a female pipe end and a second interface at the female pipe end, wherein the second interface is configured to engage with the first interface to connect the male pipe to the female pipe, and wherein the female pipe comprises a first threaded surface for engaging with a second threaded surface on the collar to secure the collar to the female pipe.

3. The union connection assembly of claim 1, wherein the male pipe groove traverses an entire circumference of the outer circumference of the male pipe, and the collar groove traverses an entire circumference of the inner circumference of the collar.

4. The union connection assembly of claim 1, wherein the collar further comprises a hole located along an outer surface of the collar, the hole on the collar configured to allow for the segmented ring to be inserted through the collar into the male pipe groove.

5. The union connection assembly of claim 1 wherein the collar further comprises a locking hole with a threaded surface, the locking hole configured to allow a locking mechanism to be inserted through the locking hole and into a pocket in the female pipe.

6. The union connection assembly of claim 5 wherein the locking mechanism comprises an outer threaded surface for engaging the threaded surface of the locking hole.

7. The union connection assembly of claim 6 wherein the locking mechanism comprises a pull pin, the pull pin having an outer sleeve, the outer sleeve comprising the outer threaded surface for engaging the threaded surface of the locking hole, wherein the pull pin comprises a handle, an insert post attached to the handle, and a spring mechanism for biasing the insert post toward an inside of the locking hole.

8. The union connection assembly of claim 6 wherein the locking mechanism is a two-piece locking pin, the two-piece locking pin comprising an outer sleeve, an inner post, and a locking ring, wherein the inner post is inserted through the outer sleeve and secured to the outer sleeve by the locking ring.

9. The union connection assembly of claim 8 wherein the collar further comprises a recess pocket, configured such that an insertion end of the two-piece locking pin can be housed in the recess pocket to allow the female pipe to be inserted into the collar.

10. The union connection assembly of claim 9, wherein the insertion end of the two-piece locking pin is a bar, and the pocket on the female collar is shaped as a slit to match the bar.

11. A method for forming a union connection comprising:
inserting a male pipe into a first aperture of a collar;
inserting a female pipe into a second aperture of the collar;
housing a segmented ring in a passageway formed by a male pipe groove and a collar groove for bearing a load between the collar and the male pipe;
securing the female pipe to the collar.

12. The method of forming a union connection of claim 11 further comprising:
engaging a first interface at a male pipe end of the male pipe with a second interface at a female pipe end of the female pipe; and
engaging a first threaded surface of the female pipe with a second threaded surface of the collar to secure the collar to the female pipe.

13. The method of forming a union connection of claim 11, wherein the male pipe groove traverses an entire circumference of an outer circumference of the male pipe, and the collar groove traverses an entire circumference of an inner circumference of the collar.

14. The method of forming a union connection of claim 11 further comprising:
inserting the segmented ring through a hole in the collar into the male pipe groove; and
inserting a retainer plug into the hole on the collar.

15. The method of forming a union connection of claim 11 wherein the collar further comprises a locking hole with a threaded surface, the locking hole configured to allow a locking mechanism to be inserted through the locking hole and into a pocket of the female pipe.

16. The method of forming a union connection of claim 15 further comprising:
engaging an outer threaded surface on the locking mechanism with the threaded surface of the locking hole.

17. The method of forming a union connection of claim 16 further comprising:
engaging a spring mechanism coupled to a handle of a pull pin, wherein the locking mechanism comprises the pull pin and the handle is coupled to an insert post; and
inserting the insert post into the pocket of the female pipe.

18. The method of forming a union connection of claim 16 further comprising:
inserting an inner post through an outer sleeve, wherein the locking mechanism is a two-piece locking pin, the two-piece locking pin comprising an outer sleeve, an inner post, and a locking ring; and
securing the inner post to the outer sleeve with the locking ring.

19. The method of forming a union connection of claim 18 further comprising:
housing an insertion end of the two-piece locking pin in a recess pocket of the collar as the female pipe is being inserted into the collar.

20. The method of forming a union connection of claim 19, wherein the insertion end of the two-piece locking pin is a bar, and the pocket on the female collar is in the shape of a slit.
